(19) United States
(12) Patent Application Publication
(10) Pub. No.: US 2012/0206915 A1
(43) Pub. Date: Aug. 16, 2012

(54) PORTABLE LIGHTING DEVICE

(75) Inventor: Marcus John Batty, Stamford (GB)

(73) Assignee: RITELITE (SYSTEMS) LIMITED, Stamford (GB)

(21) Appl. No.: 13/391,967

(22) PCT Filed: Aug. 27, 2010
(86) PCT No.: PCT/GB10/01619

§ 371 Date: May 3, 2012

(30) Foreign Application Priority Data
Aug. 27, 2009 (GB) 0914933.7

(51) Int. Cl. F21V 13/12

(52) U.S. Cl. 362/235

(57) ABSTRACT

A lighting module, particularly for a portable lamp, includes an array of light emitting diodes (LEDs), and a transparent cover arranged in front of the LEDs, the cover has a plurality of lenses on the inner surface thereof providing a respective lens in the light emission field of each LED, and a diffuser screen is positioned between the LEDs and the cover and can be moved linearly across LEDs so as to diffuse the light emission from at least some of the array or all of the array as is desired. The diffuser screen comprises a flexible polymeric material which is stored around a roller located to one side of the cover.

### FIELD

This invention relates to a portable lighting device which can produce different illumination effects.

### BACKGROUND OF THE INVENTION

It is known to provide for various different types of lamp beams by appropriate design of the configuration of the reflector, so that on the one hand a very close “spotlight” type of beam having an included angular spread of the order of 10° can be achieved, and on the other hand a wide angle “floodlight” type of beam having an angular spread of, say, 60° is possible.

GB-A-2264 164 discloses a lamp in which the configuration of a light beam can be altered by rotation of a diffuser lens divided into areas having different light diffusing properties.

A similar type of device is shown in US-A-2006056175 in which a pair of LEDs (Light emitting diodes) and in which a lens having different light diffusing properties is rotatable to positions either within or without the light emission field of the diode.

The simple rotation of a lens to alter the focus of a light source is not readily applicable to a lamp of lighting device where the illumination is provided by an array of LEDs.

The present Invention provides a lighting device having an array of LEDs as the light source together with a diffuser which can be readily placed into the light emission fields of some or all the LED's.

### STATEMENTS OF INVENTION

According to one aspect of the present invention , there is provided a lighting device or module including an array of light emitting diodes (LEDs), and a cover arranged in front of the LEDs, the cover having plurality of lenses on the inner surface thereof providing a respective lens in the light emission field of each LED, wherein a diffuser screen or shutter is operatively positioned between the LED array and the cover and can be moved across LEDs so as to diffuse the light emission from at least some of the array or all of the array as is desired.

The diffuser screen is formed from polymeric sheet material having a light transmission of between 85-92% and in use provides uniformity and directionality at transmission rates. The diffuser advantageously mixes the emissions of the multiple LEDs in the array. The diffuser can be made to shape the light beam to a desired form with diffuser angles ranging 0.5 degrees to 95 degrees in circular or elliptical profiles, as well as other forms. A light diffuser sheet material is available from POC (Physical Optics Corporation) of Torrance, Calif. and is sold under the trade designations LSD and Luminit. The sheet material may be based on PET, acrylics, or polycarbonate.

Preferably, the cover is substantially square having the screen located to one side of the cover.

In the preferred arrangement, the diffuser screen is a flexible polymeric sheet material which is stored around a roller, which may be housed in a cartridge. The preferred material is polycarbonate which has a suitable thickness which allows the material to be formed into a roll, typically between 0.005″ and 0.010″ (0.125 mm to 0.250 mm).

The roller is provided at least one end thereof with a drive knob to enable the roll to be rotated to extend the screen across the LED array or contract the screen back into the roller cartridge. The screen at its distal end is stiffened by a reinforcing strip which clips over the end of the screen and helps guide the movement of the screen.

The LED's are arranged in a substantially square array.

A second aspect of the present invention provide for a portable lamp having a battery pack and a lighting module according to a first aspect of the present invention. Preferably the lighting module is adjustably mounted at one end of the battery pack.

### DESCRIPTION OF THE DRAWINGS

The Invention will be described by way of Example and with reference to the accompanying drawings in which:

FIG. 1 is an isometric view of a lighting module according to the present invention,

FIG. 2 is an isometric view of the cover and diffuser screen,

FIG. 3 is an isometric view of the diffuser screen cartridge,

FIG. 4 is a schematic section on the line IV-IV in FIG. 1, and

FIG. 5 is an isometric view of a portable lamp apparatus also according to the present invention.

### DETAILED DESCRIPTION OF THE INVENTION

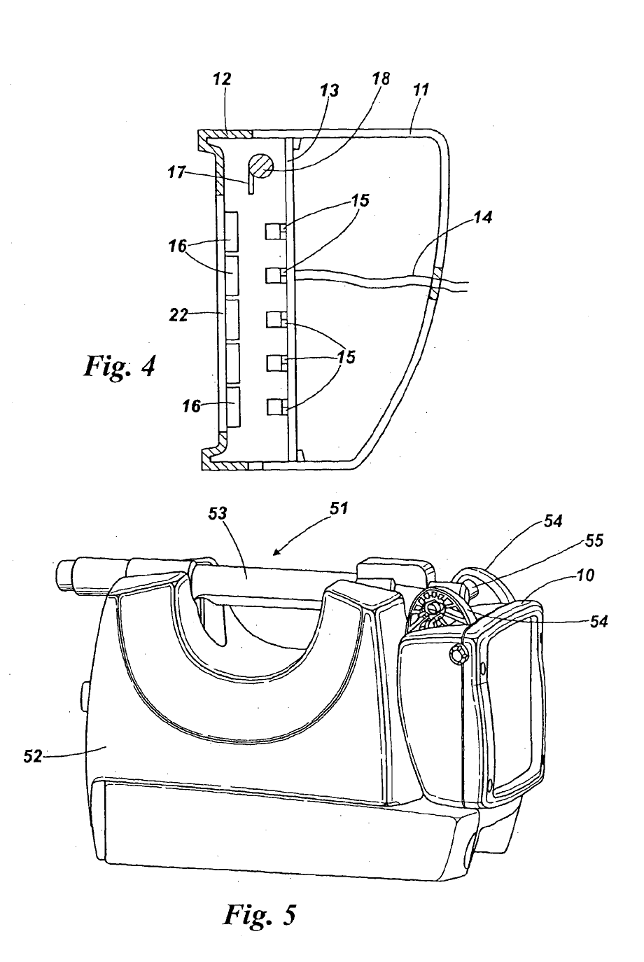

With reference to FIGS. 1-4, there is shown a lighting module 10 comprising a moulded plastics housing 11 having a front cover 12 with a transparent central portion 22. The housing 11 has a PCB (Printed Circuit board) 13 mounted therein with wires 14 connecting the PCB to an external battery pack (see FIG. 5). The PCB includes an array of high output LED's 15, in this example thirty LEDs, arranged in columns and rows in 5×6 array. Other numbers of LEDs in different arrays e.g. close packed hexagonal and a circular array, may be used as is desired and the LED output may be selected to be suitable for intended use of the lighting module. The housing 11 has a pair of mounting lugs 54 moulded on the upper outer surface thereof

The central portion 22 of the cover 12 includes a plurality of lenses 16 on the inner surface thereof, a respective lens for each LED. Preferably the lenses 16 are Fresnel lenses moulded integrally with a transparent portion 22 of the cover 12 with each lens in an active position in the light emitting field of a respective LED so that each light beam passes through a lens. The lenses 16 may focus the light emission field to for example, a 10° divergence.

A diffuser screen 17, alternatively referred to as a shutter, is located between the lenses 16 and the LEDs 15 and may be placed in light emitting fields of some or all of the LEDs. The diffuser screen 17 comprises a sheet of a transparent polymeric material having LSD surface relief holograms which are replicated from a holographically recorded master. LSDs (Light shaping diffusers) are holographically recorded, randomized surface structures. The completely random, non-periodic structures of the LSDs precisely shape, control and distribute the light passing through the diffuser sheet. Such materials are available under the trade name “Luminit”®.

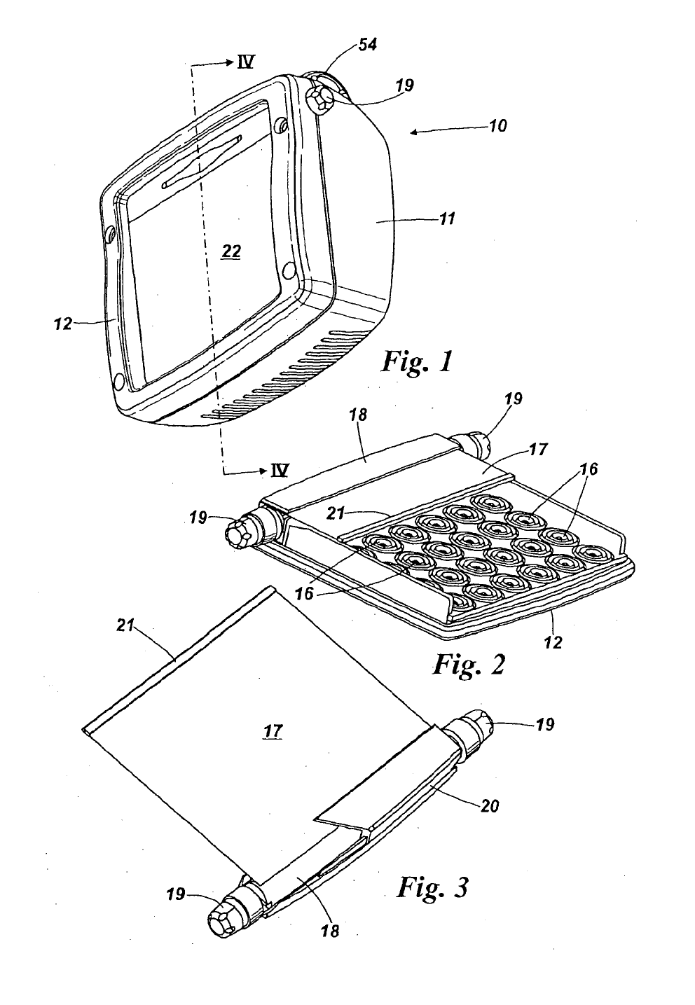

The screen 17 is typically PET or polycarbonate sheet which is sufficiently flexible to be stored on a roller 18. The roller 18 is housed in a cartridge 20 which in turn is incorporated within an upper portion of the cover 12. The screen 17 is located to one side of the substantially square transparent lens portion 22 of the cover and the light from the LEDs 15 is diffused in full or in part by linear or transverse movement of the screen across the LED array to place the screen between some or all of the LEDs 15 and their respective lenses 16. The diffuser screen or shutter 17 in FIG. 3 is shown in a fully extended condition in which it will cover all the LED's and in FIG. 2 covers a portion of the LEDs. The screen 17 is extended across the lenses 16 or retracted back onto the roller 18 by rotation of a drive knob 19 located one at each end of the roller 18 and which is external of the cover 12 and housing 11. The distal end of the screen 17 is provided with a stiffener 21 which extends across the full width of the screen and provides some guidance for the movement of the screen across the transparent portion 22 of the cover.

The diffuser screen 17 may be used to either narrow or widen the light beam emitted from the LEDs. In the present Example when the screen is fully extended the light beam from the lighting module 10 is at its widest. When the screen is fully retracted the light beam from the lighting module is at its narrowest. Alternatively, the light diffusing properties of the screen may be tailored so that the light beam can be narrowed by the imposition of the screen.

It is envisaged that similar screens could be used in combination with other shaped arrays of LEDs.

With reference to FIG. 5, the light module 10 may be incorporated into a portable lamp apparatus 51. The lamp apparatus comprises a battery housing 52 having a handle 53 and supporting the lighting module 10 which is mounted at one end thereof. The module 10 is attached to the battery housing 52 by a pin 55 passing through the anchor lugs 54 on the housing 11. This allows the lighting module 10 to be adjusted to different angles of orientation relative to the battery housing.

1. A lighting module including an array of multiple light emitting diodes (LEDs), and a transparent cover arranged in front of the LEDs, the cover having a plurality of lenses in an inner surface thereof providing a respective lens in a light emission field of each LED, wherein a diffuser screen is operatively positioned between the LED array and the cover and can be moved across LEDs so as to diffuse light emission from at least some of the array or all of the array as is desired.

2. A light module as claimed in claim 1, wherein the diffuser screen is comprises polymeric sheet material having a light transmission of between 85-92% and which mixes light emissions of the multiple LEDs in the array.

3. A light module as claimed in claim 1, wherein the cover has a substantially square transparent portion with the screen being located to one side of the cover.

4. A light module as claimed in claim 3, wherein the diffuser screen comprises a flexible polymeric material which is stored around a roller.

5. A light module as claimed in claim 4 wherein the roller is housed in a cartridge mounted within the cover.

6. A light module as claimed in claim 5, wherein the roller is provided at at least one end thereof with a drive knob to enable the roll to be rotated to extend the screen across the LED array or contract the screen back into the roller cartridge.

7. A light module as claimed in claim 4, wherein a distal end of the screen is stiffened by a reinforcing strip which clips over the end of the screen and helps guide movement of the screen.

8. A light module as claimed in claim 1, wherein the LED's are arranged in a substantially square array.

9. A portable lamp having a battery pack and a lighting module according to claim 1.

10. A lamp as claimed in claim 9, wherein the lighting module is located at one end of the battery pack and orientation of the module relative to the battery pack is adjustable.
